(19) United States
(12) Patent Application Publication
(10) Pub. No.: US 2005/0177609 A1
(43) Pub. Date: Aug. 11, 2005

(54) Applications of discrete calculus

(76) Inventor: Virginia C. Harrison, Berkeley, CA (US)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/959,399

(22) Filed: Oct. 6, 2004

Related U.S. Application Data
(60) Provisional application No. 60/508,984, filed on Oct. 7, 2003.

(51) Int. Cl. G06F 7/38

(52) U.S. Cl. 708/446

(57) ABSTRACT

A mathematical theory of chainlets is presented as an infinite series of simple domains such as squares, triangles or molecular points. Chainlets are shown to be able to represent both smooth and nonsmooth pictures and serve as domains of integration, providing an extension of wavelet theory and Fourier analysis useful for data compression, signal processing among other applications.

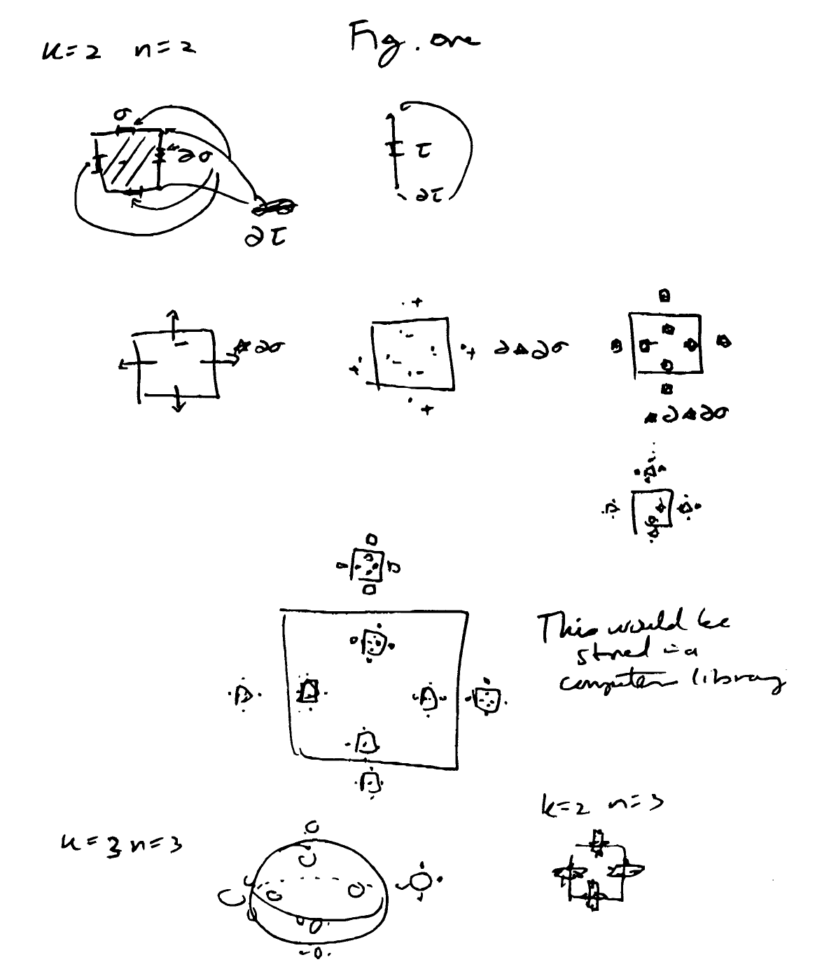

### CLAIM TO PRIORITY

This application claims the benefit of co-pending United States provisional patent application entitled “Applications of Discrete Calculus” filed Oct. 7, 2003 and assigned Ser. No. 60/508,984, which is incorporated by reference herein.

Applications to data compression. There is enormous potential for chainlets to aid with data compression. In these pages one can see how to naturally approximate a complicated object by a discrete chain that is much simpler.

Elsewhere, I have shown how to define an inner product.

THEOREM 0.1.
<A,E>≦|A|₁|E|₁
Proof. We have E=X∩M for some X. Then
<A,X∩M>=|X·A|≦|X|₁|A|₁
We are reduced to showing that |X|₁≦|X∩M|₁. See your paper Cambridgepoincare.tex.

Here is the standard definition of inner product:
<E, E>≧0 We must restrict this to elements of the subspace Y. If E is a basis element of Y then ∫_{E}ω_{E}=1. In general, if E=ΣᵢaᵢEᵢ is a finite sum, then the integral is Σaᵢ². This is zero if and only if the aᵢ are all zero.
<tA,E>=<A,tE>=t<A,e> for all t.
<A,E+F>=<A,E>+<A,F> and <A+B,E>=<A,E>+<B,E>.
<E, F>=<F, E> for elements in Y. This will take a proof but looks good. These really amount to integrating the wedge product of the associated forms. You have to take care with the signs.
Define ∥E∥=<E,E>^{(1/2)}. Which norm is this? Show
   ∥E∥=|E|₁.

We know
<E,E>=|X·(X∩M)|≦|X|₁|(X∩M)|₁≦|(X∩M)|₁²=|E|₁².
This should generalize to r-norms. Now for the other direction: Write E=ΣaᵢEᵢ. Then
|E|₁²≦(Σ|aᵢ||Eᵢ|₁)²=(Σ|aᵢ|)²=Σ|aᵢ|²=<E,E>.

The construction of a rigged Hilbert space is taking shape. If you can do this then wavelets over chainlets is not only cute, but may have large application. You have ∫_{A}f You write f as a series Σbᵢgᵢ where bᵢ=<f,gᵢ>. Similarly, you write A=ΣaᵢEᵢ where aᵢ=<A,Eᵢ>. Then the integral is approximated by a double sum ΣΣaᵢbⱼ∫_{E}_{ᵢ}gⱼ. The terms ∫_{E}_{ᵢ}gⱼ will be standard and easy. Call these c_{i,j}. They may even be homothetic replicas. Then the integral is approximated by ΣᵢΣⱼaᵢbⱼcᵢⱼ.

This surely is useful for data compression. You could have a library of coefficients as for your favorite domain. These exist for functions. Then all sorts of operations are quick. Integration is just one. There is boundary, Hodge*, flux, etc. You may be able to solve PDE's using this.

How to set up the theory: You start with a Riemannian manifold as your ambient space. You say that a Banach space X is a partial Hilbert space over a locally compact set U⊂M (open set?) if Hodge* is defined on X, boundary is defined, components are defined, and there exists a dense subspace Y and an inner product <, > defined on X×Y.

You want the space Y to contain an orthonormal basis for X. This might be easy to construct in general. It is easy for your application. You could start with any Y with at least one element that has support containing U. Take *Y and its components. You need some form of binary cubes relative to Y and then restrict these elements to the cubes. Normalize them.

Now take the span of these new elements to get minimal Y extending Y.

In Euclidean space you use binary cubes and dx. Let Cᵢ denote the chainlet of dx restricted to the cube Qᵢ.
Define
   <A,B>=∫_{A}D_{B}.
where D_{B} is the form that gives rise to B.
   THEOREM 0.2. Given a chainlet A then
   A=lim_{k→∞}Σᵢ<A,Cᵢ>Cᵢ.
   THEOREM 0.3. Given a current T then
   T(ω)=lim_{k→∞}ΣᵢT(dxᵢ)∫_{E}_{ᵢ}ω.

You are going to want to use the sides Eᵢ of the cubes instead of the chainlet Cᵢ defined over the cube. Note.
ΣᵢaᵢCᵢ=ΣᵢaᵢEᵢ+Σᵢaᵢ(Cᵢ−Eᵢ)

You need the following estimate:
|Σᵢaᵢ(Cᵢ−Eᵢ)|≦2^{-k}Σaᵢ.
But Σaᵢ=∫_{A}dx. So you are in business. You are now officially unstuck! I don't think anyone else knows how to do this because it uses so much of the theory. This looks really nice.

What are sheaves? You may be using them here.

### EXAMPLES

(1) Dirac δ distribution. Approximate δ with binary line segments normalized. Integrate dx over them. You get appropriate approximators.
(2) The x-component of the graph of an L¹ function. You cover the graph with binary squares and integrate dx over the bottom part normalized, denoted Eᵢ. Then the graph is approximated by
   Σᵢ(∫_{A}|_{Qi}dx)Eᵢ
This is closely related to the Haar basis.
(3) smooth manifold embedded in Rⁿ. Cover with binary cubes. The coefficients will be the projected mass. A very simple example is the diagonal.
You approximate it with a staircase. Each step is normalized, the coefficient is the length of the step. (This is slightly awkward since this is the same as the un-normalized step with coefficient 1, but the process generalizes.)
(4) the snowflake. This has a nice picture that you have drawn before. You put binary squares inside the snowflake and take the boundary. This limits to the snowflake in the 1-norm. This example is nonrectifiable.

Now consider other operators than the integral. ∂Σ<A, Cᵢ>Eᵢ=Σ<A,Cᵢ>∂Eᵢ=Σ<∂A,Cᵢ>E₁.

The last equality is a nice theorem.

THEOREM 0.4. If A is a chainlet then

Σ<A,Cᵢ>∂Eᵢ=Σ<∂A,Cᵢ>Eᵢ.

THEOREM 0.5. If A is a chainlet then
Σ<A,Cᵢ>*Eᵢ=Σ<*A,Cᵢ>Eᵢ.

The other operators you always talk about behave simiarly.

THEOREM 0.6. <∂A,C>=<A,δC>.

Proof. This reduces to Stokes' theorem. Given a form ω, let X denote the cochain and C=*(XωM) the chainlet dual of X. I think this is *PD(X). Then
*∂*C=*∂(X∩M)=*(dX∩M).
So
<∂A,C>=∫_{∂A}ω=∫_{A}dω=<A,*∂*C>.

You can surely prove that
<ΔA,C>=<A,ΔC>.

You want to express each current in terms of simple basis cubelets from the faces of binary cubes. The question is what are the coefficients?

You already know that there is a special subspace of chainlets which is the image of cochains under the Poincare duality homomorphism. This is going to be the subspace from which you can choose bases and apply Hilbert space methods. It won't be the same as a Hilbert space, but similar. Every chainlet will be a linear combination of inner products of the current and cochain times basis vectors. What you are thinking and not writing and will confuse others is that you know a correspondence between these special chainlets and cochains. For example, dx corresponds to a smeared out chainlet in the x-direction. It looks like the integral curves of dx. A normalized restriction of this chainlet will be a basis element E. You take the inner product of c with dx and multiply this number times E. Whew!

So we end up with an inner product that is defined for all pairs of chainlets where one is a member of the subspace J. This is enough to do Gram Schmidt process.

You also know that every current is a form with distributional coefficients. This is what was missing from the last few days.

Define the inner product <c,β>=c(β). Check that if the current c is a form then this is the standard inner product. <α,β>=∂αΛ*β=α(β).

More generally, Start with a nonzero form ω in the subspace J. Its support should contain the support of the current T. This is a cochain X. Let F be the chainlet of this cochain under Poincare dual. (You might have to construct F using the pushforward operation and partition of unity construction.) You need other cochains that are transverse to X. If these have invariant transverse measures then you can use them to define binary cubes.

Let E be the restriction of F to a binary cube Q.

LEMMA 0.7.
Δ(<fdx,dx|_{Q}>E)=<Δfdx,dx|_{Q}>E.
Proof. We know from the material below that the Lie derivative of a chainlet is a chainlet. We also know that two chainlets are identical if and only if their integrals are the same for all forms.
∫_{Δ(<fdx,dx|}_{_{Q}}_{>E)}ω=∫_{<fdx,dx |}_{_{Q}}_{>E}δω=∫_{E}(<fdx,dx|_{Q}>)Δω
and
   ∫_{<Δfdx,dx|}_{_{Q}}_{>E)}ω=∫_{E}<Δfdx,dx|_{Q}>ω.
   It remains to show that
   ∫_{E}(<fdx,dx|_{Q}>)∫_{E}<Δfdx,dx|_{Q}>ω.
   That is, in Q
   (<fdx,dx|_{Q}>)Δω=<Δfdx,dx|_{Q}>ω
   To prove this, we show
   (∫_{Q}fdA)Δω=(∫_{Q}ΔfdA)ω
   or at least the ratio tends to one as |Q|→O.

With the lemma, we know that if T is a current which is of the form Δfdx then the associated chainlet is of the form ΔA where A is associated to fdx

THEOREM 0.8. If T is a current supported in a cube Q, then the sequence of polyhedra chains Pₖ=Σ₁Σ_{Qk}∫_{Qk}<T,dx₁|_{Qk}>Eₖ converges to a chainlet A and T (ω)=∫_{A}ω. Furthermore the norms are equivalent.

Proof. We first prove this for T=fdx where f is continuous. Note that T(dx)=∫_{Q}fdA which is about Σᵢf(pᵢ)2^{-k}. Set
Pₖ=ΣT(dx|_{Qi})\acute{\hat{E}}ᵢ.
Then
Pₖ=Σ<fdx,dx|_{Qi}>\acute{\hat{E}}ᵢ=Σ(∫_{Q}fdA)\acute{\hat{E}}ᵢ˜Σf(pᵢ)2^{-2k}(Eᵢ/2^{-k})
Then Pₖ˜Σf(pᵢ)^{2-k}Eᵢ.

Now T(Pdx)=∫_{Q}fpdA. Subdivide Q into smaller k-squares Qᵢ. We prove the latter is about ∫_{Pk}Pdx. The result will follow.

Break these integrals into a sum of integrals over smaller cubes Qᵢ. Show
∫_{f(p}_{ᵢ}₎₂_{^{−k}}_{E}_{ᵢ}Pdx˜∫_{Qi}fPdA
The latter is about ∫_{f(p}_{ᵢ}_{)Q}_{ᵢ}PdA.
But clearly,
∫_{f(p}_{ᵢ}₎₂_{^{−k}}_{E}_{ᵢ}Pdx˜∫_{f(p}_{ᵢ}_{)Q}_{ᵢ}PdA.

Next we move to the case T=Δfdx. We show that
T(ω)=∫_{ΔA}ω

This will imply that ΔA is a chainlet representing T. By the Lemma
∫_{ΔA}ω˜∫_{ΔE<fdx,dx|Q>\acute{\hat{E}}i}ω=∫_{Σ<Δfdx,dx|Qi>\acute{\hat{E}}i}ω.

Thus the coefficients are obtained using the general method.

Another application is to use the faces of binary cubes as basis. The coefficients would be action of the current c on dx restricted to that cube. The resulting sequence of polyhedral chains is Cauchy. You end up with a series of actions of c on dx, restricted to a small binary cube multiplied by translation of the appropriate normalized faces. The entire action of c on dx over the larger cube is bounded.

Chainlets form a Banach space, but not a Hilbert space. The way to see this is to consider L¹ functions as 1-chainlets. If there were an inner product on chainlets, it would induce one on L functions which is not possible. However, there may be a way around this. You have the Poincare dual mapping taking cochains into chains. Consider all cochains X Let B=PD(X). We will define an “inner product” of a chainlet A with this subspace of chainlets. <A,B>=X·A.

Next we try to find a “basis” of cochains, that is, a collection of nonzero cochains X₁ that are transverse to each other. Let B₁ denote the image of X₁ under PD. We will try to prove a theorem something like:

THEOREM 0.9. Given a chainlet A supported in the supports of the B₁. Then
A=Σ₁<A,B₁>B₁.

A natural example is that of the basis dx₁ in Rⁿ. You can equivalently use faces E₁ of the binary grid for the basis instead of B₁.

THEOREM 0.10. Every current c can be expressed as a chainlet.

You transform the preceding construction. Let ω₁ denote the form associated to X₁. Define
A_{c}=Σ₁c(ω₁)B₁.

Then
∫_{Ac}ω=c(ω)

Ultimately, you can write a current acting on a form as a sum of basic functions integrated over cubes. This is because the B, can be approximated by cubes. The form has a Fourier series or wavelet expression.

This will be useful for data compression.

Applications to Vision:

I will next summarize four problems of vision that seem amenable to this approach. I believe progress on any of them would be a noteworthy achievement.

1. How do we recognize and quantify boundaries, or edges of objects? The theory of chainlets shows that boundaries are not just frontiers of sets, but have their own weight or density functions(?) For example, the boundary of a red ball against a blue sky has a larger weight than the boundary of a blue ball against a blue sky. The larger this weight function, the easier it is for us to see the boundary, thus the object itself.

2. How may we quantify the difference between two objects? For example, two wooden chairs may be essentially the same or somewhat different, or quite different. A method to quantify the difference between two objects could be very valuable when considering computer images of tumors, for example. One might ask, “Has there been significant change in the appearance of the tumor over a period of time?” “Is the boundary of one tumor more fractal that the boundary of another more benign one?” In the theory of chainlets, there are norms which can be used to tackle this basic question. (?).

3. How do we re cognize a three-dimensional solid form its two-dimensional projection? This is a question that I am looking at with David Forsyth because he has written a paper on this problem. I believe it involves integrating over the difference between the slightly translated pictures that the left and the right eye see(?).

4. How do we know when it is safe to cross the road? We see a car approaching and we can predict where it will be in the next few seconds. How do we do this? This is known as the “top/down, bottom/up” problem. We see a moving picture which translates in our brain into a signal that changes in time. We are able to process the signal forward in time and then recreate a picture of a car from the predicted signal. A major theorem in the theory of chainlets is a duality result (?) that should be able to answer this.

Application to Vision: It appears that the mathematical theory of chainlets I have been developing for the past decade has direct applications to the field of vision. This is a recent and exciting discovery. The theory appears to have broad application and carries with it powerful new tools that at this time are not widely. The objects defining chainlets are tiny squares, each assigned a real number. One can represent this associated number with a shade of gray. (It is trivial to extend these comments to colored pictures). Zero corresponds to no shade, the larger the number, the darker the shade. The theory shows how one can represent a gray scale picture as an infinite collection, or series, of small shaded squares. This infinite series is called a chainlet. Using chainlets, you can represent a smooth picture such as a smooth ping pong ball or a nonsmooth picture such as a clouds, trees or rust. A chainlet has a well defined boundary. For example, a round ball has a circular boundary. A torn page will have a more complex boundary that is not particularly smooth.

Chainlets, rough or smooth, can serve as domains of integration as long as the integrands used are smooth. This duality of rough and smooth is a major part of the theory. In human vision, there is a counterpart in the brain to the basic smooth integrands dxdy, dx, dy. When we look at something we are basically integrating, or averaging, the amount of light we see. So there is a rough correspondence between the physical and mathematical concepts. Rough domains of pictures are paired with smooth integrands of physiology. With this basic matching of theory and the real world, one can then apply several theorem I have proved about chainlets to try to solve problems in vision.

1. A method for compressing numerical data for efficient storage comprising: approximating said numerical data with a discrete series of chainlets and storing the chainlet coefficients of said discrete series.
